(19) United States
(12) Patent Application Publication
(10) Pub. No.: US 2010/0086348 A1
(43) Pub. Date: Apr. 8, 2010

(54) METHOD OF JOINING CABLE RACKS, AND A SPLICE PLATE

(75) Inventors: Jun FUNAHASHI, Tokyo (JP); Tadayoshi IBAYASHI, Tokyo (JP); Jun KADOWAKI, Tokyo (JP); Koji MATSUKAWA, Tokyo (JP); Eisaku ASATSUMA, Tokyo (JP); Junichi KATO, Tokyo (JP); Junpei SHIBATA, Tokyo (JP); Akihiro KITAJIMA, Tokyo (JP); Toshihiko ABE, Tokyo (JP); Seiichi SAKAMOTO, Tokyo (JP); Koji UCHIYAMA, Tokyo (JP); Hiroshi HARIKAGO, Tokyo (JP); Zhang MENG, Tokyo (JP)

Correspondence Address: Studebaker & Brackett PC, One Fountain Square, 11911 Freedom Drive, Suite 750, Reston, VA, 20190, US

(73) Assignee: BURESUTO KOGYO CO., LTD., Tokyo (JP)

(21) Appl. No.: 12/328,947

(22) Filed: Dec. 5, 2008

(30) Foreign Application Priority Data
Dec. 7, 2007 (JP) 2007-317751

(51) Int. Cl. F16B 5/02; B23P 11/00; F16B 5/00

(52) U.S. Cl. 403/306; 29/525.02

(57) ABSTRACT

Disclosed is a technique of joining two cable racks together in a longitudinal direction thereof. A splice plate is used which has two insertion holes each formed at a position corresponding to a first one of two joint holes in each of adjacent ends of each of two longitudinally-aligned pairs of primary beams of two cable racks, and two lock protrusions each formed at a position corresponding to the other second joint hole, in a manner engageable with the second joint hole. The adjacent ends of the longitudinally-aligned pair of primary beams are joined together by means of engagement between the lock protrusions of the splice plate and the second joint holes of the adjacent ends of the longitudinally-aligned pair of primary beams, and fastening between two bolt and two nuts through the first insertion holes and the insertion holes of the splice plate. Thus, two cable racks can be joined together by performing a bolting operation only at a single position in each of the adjacent ends of the longitudinally-aligned pair of primary beams. This makes it possible to reduce by half a time of joining operation while suppressing a trouble in the joining operation.

### BACKGROUND OF THE INVENTION

1. Field of the Invention

The present invention relates to a method of joining two cable racks together in a longitudinal direction thereof, and a splice plate for use in the method.

2. Description of the Background Art

In various architectural structures, such as office buildings, industrial plants and station buildings, cable racks are set up to allow a cable to be laid out therealong. This type of cable racks have a ladder-like structure in which two primary beams extending in parallel relation to each other are connected together by a plurality of secondary beams disposed therebetween at certain intervals. Commercially-available cable racks are limited to several types each having a given length. Thus, when it is necessary to lay out a cable over a long distance, a plurality of cable racks are used by joining them together in a longitudinal direction thereof.

In such a case, a splice plate 30 having a configuration as shown in FIG. 11 has been conventionally used for joining two cable racks 1 together, wherein the splice plate 30 is positioned so as to cover respective adjacent ends of the two cable racks 1, and fastened to each of the two cable racks 1 by bolts and nuts.

More specifically, as shown in FIG. 10, the cable rack 1 has a ladder-like structure in which two primary beams 2 extending in parallel relation to each other are connected together by a plurality of secondary beams 3 disposed therebetween at certain intervals. In order to ensure desired strength, each of the primary beams 2 has first and second bent edge plate portions 22, 23 extending from respective upper and lower edges of a vertical planar plate portion 21 inwardly in a direction perpendicular to the planar plate portion 21, and a planar depressed plate portion 26 formed by depressing a generally vertically central region of the planar plate portion 21 inwardly in a manner continuous with an upper step portion 24 and a lower step portion 25.

Each of the secondary beams 3 is provided such that lower surfaces of opposite ends thereof are weldingly fixed to respective upper surfaces of the second (i.e., lower) beam edge portions 23 of the two primary beams 2 positioned in parallel relation to each other. Each of the primary beams 2 has two joint holes 27 which are formed in each of opposite longitudinal ends of the depressed plate portion 26 to allow a bolt to be inserted thereinto, and arranged longitudinally in side-by-side relation to each other.

In order to allow the splice plate 30 to be positioned in such a manner so as to cover respective adjacent ends of each of two longitudinally-aligned pairs of the primary beams 2 in the two cable racks 1, from an outside of the cable racks 1, as shown in FIG. 11, the splice plate 30 has first and second bent plate edge portions 32, 33 extending from respective upper and lower edges of a vertically planar plate portion 31, and a vertically planar depressed plate portion 34 formed by depressing inwardly a generally vertically central region of the planar plate portion 31. The splice plate 30 also has four insertion holes 35 formed in the depressed plate portion 34 at positions corresponding to the respective four joint holes 27 which are formed in the adjacent ends of the longitudinally-aligned pair of primary beams 2, and arranged longitudinally in side-by-side relation to each other.

In the conventional structure illustrated in FIG. 11, respective adjacent ends of each of the two longitudinally-aligned pairs of primary beams 2 are joined together without wobbling movement by the splice plate 30, in the following manner. After aligning the two cable racks 1 in the longitudinal direction thereof, the splice plate 30 is positioned so as to cover respective adjacent ends of the longitudinally-aligned pair of primary beams 2, from the outside of the cable racks 1. Then, with respect to one of the two longitudinally-aligned pairs of primary beams 2, i.e., one side of the two cable racks 1, total four bolts 4 (i.e., two bolts per primary beam 2) are inserted into the respective four joint holes 27 of the longitudinally-aligned pair of primary beams 2 and the corresponding four insertion holes 35 of the splice plate 30, from the inside of the cable racks 1. Then, four nuts 5 are fastened to the respective bolts 5 from the outside.

In the joining technique using the conventional splice plate 30, it is required to perform a bolting operation at two positions with respect to each of the adjacent ends of the longitudinally-aligned pair of primary beams 2, i.e., at four position on one side of the two cable racks 1, or at total eight positions on both sides of the two cable racks 1. Thus, the entire joining operation becomes cumbersome, complicated and too time-consuming. Particularly, in many cases, the cable racks are set up at a relatively high location in an architectural structure. Thus, the bolting operation to be performed eight times at a high location is generally troublesome. Moreover, it is required to pay careful attention so as to prevent accidental drop-off of a bolt or nut during the operation at a high location.

As measures for the above problems, it has been proposed a technique of additionally providing a reverse bent portion (i.e., lock portion) to extend from a distal edge of at least an upper one of the first and second bent plate edge portions 32, 33 of the splice plate 30, in a manner engageable with the first (i.e., upper) bent edge plate portion 22 of the primary beam 2 of the cable rack 1 in FIG. 11, so as to increase a retaining force relative to the longitudinally-aligned pair of primary beams 2 in the two cable racks 1 during a temporary joint operation to allow the number of bolting positions to be reduced by half, i.e., reduced to two bolting positions on one side of the cable racks 1, as disclosed in the following JP 2001-292517A.

In the above technique, it is required to additionally form the lock portion at least in an upper region of the splice plate, which causes a problem of an increase in production cost of the splice plate.

For that reason, there has also been proposed a technique of forming a splice plate in a planar shape capable of being fitted into the depressed plate portion 26 of the primary beam 1 in FIG. 11, and providing a protrusion on a lower edge of the depressed plate portion 26 contactable with a lower edge of the splice plate, as disclosed in the following JP 3341163B.

In some actual cable rack joining operations, an end of a cable rack is out off in an installation site in order to adjust a length thereof. In such cases, the above technique has a problem that, after the cutting operation, a new protrusion has to be accurately formed on the cut end of the primary beam in the installation site.

Further, in some actual cable rack joining operations, two cable racks are joined together while providing a certain gap therebetween in consideration of thermal expansion and shrinkage. In such cases, the above planar-shaped splice plate fittable into the depressed plate portion 26 will expose a part of the gap between the longitudinally-aligned pair of primary beams, on upward and downward sides thereof. This causes the appearance to be poor and the appearance causing operator's anxiety about its strength.

### SUMMARY OF THE INVENTION

In view of the above problems, it is an object of the present invention to provide a method of joining two cable racks together, which is capable of allowing the number of bolting positions on one side of the two cable racks to be reduced to two, and coping with cut-off of an end of the cable rack, while facilitating a reduction in production cost. It is another object of the present invention to provide a splice plate for use in the method.

In order to achieve the above objects, according to one aspect of the present invention, there is provided a method of joining two cable racks together in a longitudinal direction thereof, wherein each of the cable racks has two primary beams each having a vertically planar plate portion, and first and second bent edge plate portions extending from respective upper and lower edges of the planar plate portion inwardly in a direction perpendicular to the planar plate portion; and a plurality of secondary beams connecting the two primary beams together in such a manner that opposite ends of each of the secondary beams are fixed to respective upper surfaces of the second bent edge plate portions of the two primary beams, and wherein each of the two primary beams has two joint holes which are formed in each of opposite longitudinal ends of the planar plate portion, and arranged longitudinally in side-by-side relation to each other. The method comprises the steps of: aligning the two cable racks to each other in the longitudinal direction thereof; providing a splice plate which comprises: a vertically planar plate; and first and second bent plate edge portions extending from respective upper and lower edges of the planar plate portion in such a manner as to cover respective adjacent ends of each of two longitudinally-aligned pairs of the primary beams of the two cable racks, from an outside of the two cable racks, wherein said planar plate portion has two insertion holes each formed at a position corresponding to a first one of the two joint holes in each of the adjacent ends of the longitudinally-aligned pair of primary beams, and two lock protrusions, each formed at a position corresponding to the other second joint hole, in a manner engageable with the second joint hole; pressing the planar plate portion of the splice plate, against the two planar plate portions of the adjacent ends of the longitudinally-aligned pair of primary beams, while placing the first and second bent plate edge portions of the splice plate, on respective ones of the two pairs of first and second bent edge plate portions of the adjacent ends of the longitudinally-aligned pair of primary beams, from the outside of the two cable racks, to bring the two lock protrusions of the planar plate portion of the splice plate into engagement with the respective second joint holes of the two planar plate portions of the adjacent ends of the longitudinally-aligned pair of primary beams; and inserting a bolt into the first joint hole in each of the adjacent ends of the longitudinally-aligned pair of primary beams, and a corresponding one of the two insertion holes of the splice plate, and fastening a nut to the inserted bolt from the side of a distal end of the inserted bolt to clamp the two planar plate portions of the adjacent ends of the longitudinally-aligned pair of primary beams, and the planar plate portion of the splice plate, between the bolt and the nut.

In the above method of the present invention, the planar plate portion of the splice plate is pressed against the two planar plate portions of the adjacent ends of the longitudinally-aligned pair of primary beams, from the outside of the two cable racks, to bring the two lock protrusions of the planar plate portion of the splice plate into engagement with the respective second joint holes of the two planar plate portions. Then, in this state, a bolt is inserted into the first joint hole in each of the adjacent ends of the longitudinally-aligned pair of primary beams, and a corresponding one of the two insertion holes of the splice plate, and a nut is fastened to the inserted bolt from the side of a distal end of the inserted bolt to join the respective ends of the longitudinally-aligned pair of primary beams of two cable racks together in a longitudinal direction thereof. Thus, in this method, a bolting operation is performed only at one position with respect to each of the adjacent ends of the longitudinally-aligned pair of primary beams, i.e., at two position on one side of the two cable racks, or at total four positions on both sides of the two cable racks. That is, the number of bolting operations can be reduced by half as compared with the conventional technique. This also makes it possible to reduce by half a time of the entire joining operation and a problem in the joining operation.

In addition, the respective ends of the longitudinally-aligned pair of primary beams of the two cable racks can be joined together in a longitudinal direction thereof by pressing the planar plate portion of the splice plate against the two planar plate portions of the adjacent ends of the longitudinally-aligned pair of primary beams, from the outside of the two cable racks, to bring the two lock protrusions of the planar plate portion of the splice plate into engagement with the respective second joint holes of the two planar plate portions, inserting a bolt into the first joint hole in each of the adjacent ends of the longitudinally-aligned pair of primary beams, and a corresponding one of the two insertion holes of the splice plate, and fastening a nut to the inserted bolt from the side of a distal end of the inserted bolt. This makes it possible to eliminate the need for additionally providing the reverse bent portion extending from a distal edge of at least the first bent plate edge portion of the splice plate, in a manner engageable with the first bent edge plate portion of the primary beam, so as to facilitate a reduction in production cost.

Furthermore, the method of the present invention can cope with the problem caused by the protrusion in an end of the primary beam which is formed due to cut-off of an end of a primary beam.

In another aspect of the present invention, a pair of splice plates with the same lock protrusions can be employed to join respective adjacent ends of two cable racks together, in such a manner that the two cable racks are adjustably rotated and positioned relative to each other to allow one of the two cable racks to be inclined relative to the other cable rack with respect to a longitudinal-lateral plane of the two cable racks in a longitudinally aligned state.

In a yet another aspect of the present invention, a pair of splice plates with the same lock protrusions can be employed to join respective adjacent ends of two cable racks together, in such a manner that the two cable racks are adjustably rotated and positioned relative to each other to allow one of the two cable racks to be inclined laterally relative to the other cable rack in approximately the same longitudinal-lateral plane of the two cable racks in a longitudinally aligned state.

### BRIEF DESCRIPTION OF THE DRAWINGS

FIG. 1 is a perspective view showing a splice plate according to a first embodiment of the present invention.

FIG. 2 is a perspective view showing the splice plate according to the first embodiment during use.

FIG. 3 is a sectional view showing the splice plate according to the first embodiment during use.

FIG. 4 is a side view showing the splice plate according to the first embodiment during use.

FIG. 5 is a perspective view showing a splice plate according to a second embodiment of the present invention.

FIG. 6 is a perspective view showing a splice plate according to a third embodiment of the present invention.

FIG. 7 is a perspective view showing a splice plate according to a fourth embodiment of the present invention.

FIG. 8 is a perspective view showing a splice plate according to a fifth embodiment of the present invention.

FIG. 9 is a perspective view showing a splice plate according to a sixth embodiment of the present invention, during use.

FIG. 10 is a perspective view showing two cable racks.

FIG. 11 is an explanatory perspective view of a conventional cable rack joining technique.

### DESCRIPTION OF THE PREFERRED EMBODIMENTS

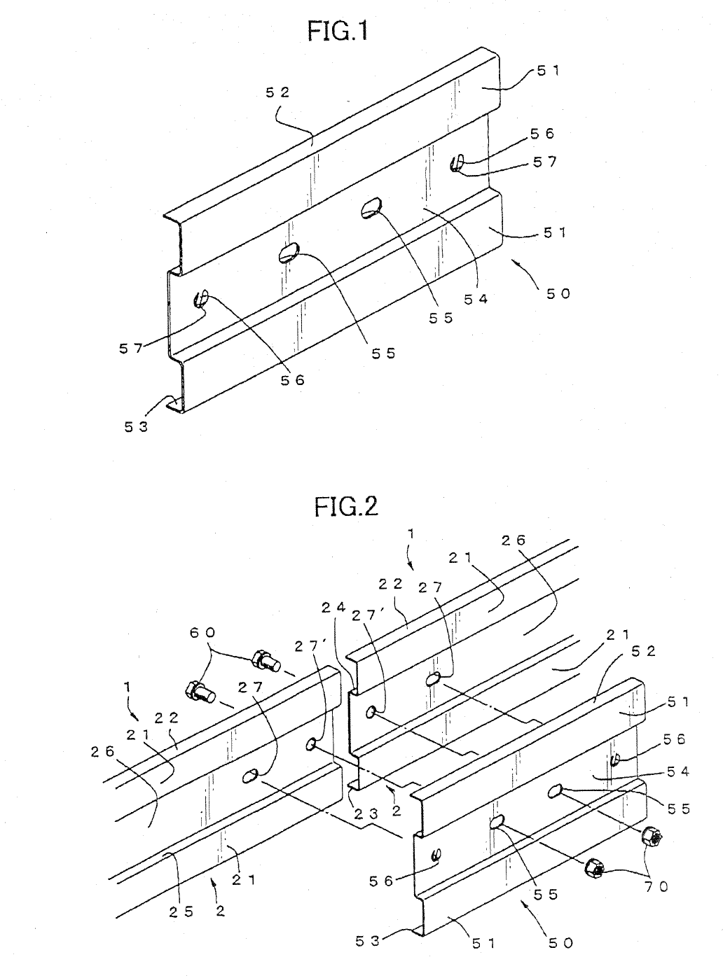

With reference to the drawings, the present invention will now be described based on an embodiment thereof. FIG. 1 shows a splice plate according to a first embodiment of the present invention.

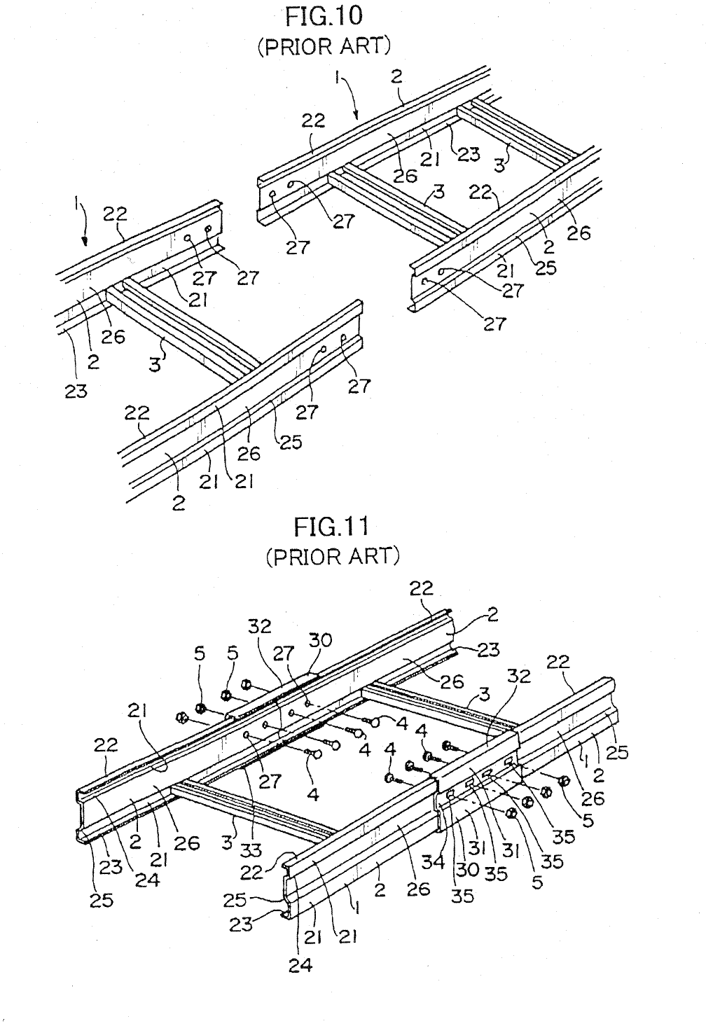

As already described in connection with FIG. 10, a cable rack 1 has a ladder-like structure in which two primary beams 2 extending in parallel relation to each other are connected together by a plurality of secondary beams 3 disposed therebetween at certain intervals. In order to ensure desired strength, each of the primary beams 2 has first and second bent edge plate portions 22, 23 extending from respective upper and lower edges of a vertically planar plate portion 21 inwardly in a direction perpendicular to the planar plate portion 21, and a vertically planar depressed plate portion 26 formed by depressing a generally vertically central region of the planar plate portion 21 inwardly in a manner continuous with an upper step portion 24 and a lower step portion 25.

The two primary beams 2 positioned in parallel relation to each other are connected together by a plurality of secondary beams 3, in such a manner that lower surfaces 3a of opposite ends of each of the secondary beams 3 are placed on respective upper surfaces of second (i.e., lower) beam edge portions 23 of the two primary beams 2 while bringing upper corners 3b of the ends of the secondary beam 3 into contact with respective inner surfaces of inclined lower step portions 25 of the two primary beams 2, and then weldingly fixed to the respective upper surfaces of the second beam edge portions 23.

As shown in FIG. 2, each of the primary beams 2 has two joint holes 27 which are formed in each of opposite longitudinal ends of the depressed plate portion 26 and arranged longitudinally in side-by-side relation to each other. Upper and lower portions of the depressed plate portion 26 are formed as upper and lower step portions 24, 25, respectively.

A splice plate 50 illustrated in FIG. 1 as the first embodiment of the present invention is designed to join the two cable racks 1 together in a longitudinal direction thereof.

The splice plate 50 has a vertically planar plate 51, first and second bent plate edge portions 52, 53 extending from respective upper and lower edges of the planar plate portion 51 in such a manner as to cover respective adjacent ends of each of two longitudinally-aligned pairs of the primary beams 2 in the two racks 1, and a vertically planar depressed plate portion 54 formed by depressing a generally vertically central region of the planar plate portion 51 inwardly.

The splice plate 50 also has two insertion holes 55 each formed in the depressed plate portion 54 at a position corresponding to a first one 27′ of two joint holes 27, 27′ which are formed in each of the adjacent ends of the longitudinally-aligned pair of primary beams 2, and arranged longitudinally in side-by-side relation to each other, and two lock protrusions 56 each formed to protrude inwardly (i.e., toward an outer surface of the longitudinally-aligned pairs of primary beams 2) at a position corresponding to the other second joint hole 27, in a manner engageable with the second joint hole 27.

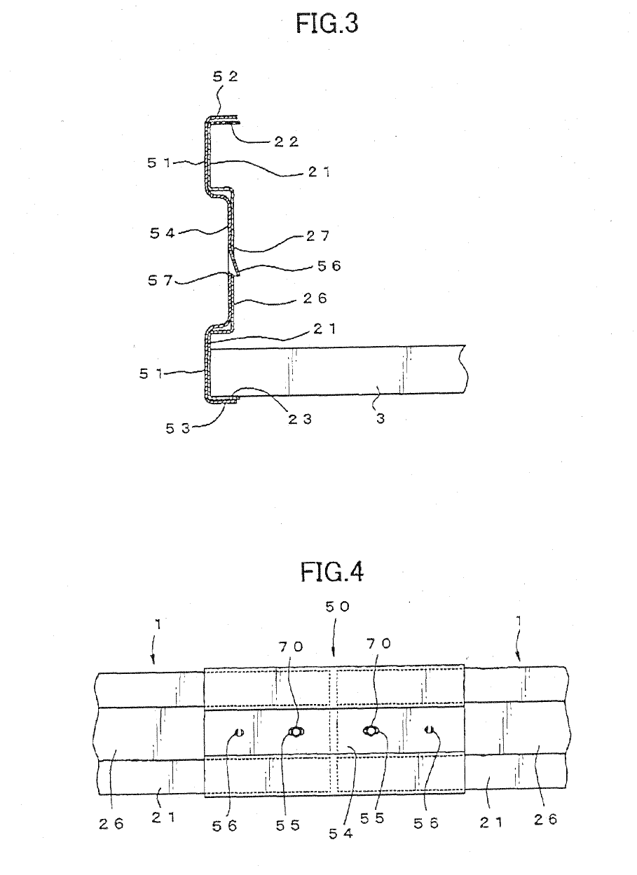

Each of the lock protrusions 56 may be formed as a cut-and-bent portion by press working, for example, to have a cut-and-bent shape in which a circular region of the depressed plate portion 54 protrudes inwardly, wherein an amount of protrusion in the circular region gradually increases in a downward direction, and the circular region has an arc-shaped cut portion 57 in a lower edge thereof, as shown in FIGS. 1 and 3.

A method of joining the two cable racks 1 (see FIG. 10) together in the longitudinal direction using the above splice plate 50.

As shown in FIG. 2, the two joint holes 27, 27′ are formed in the end of the depressed plate portion 26 of the primary beam 2 of the cable rack 1, and arranged longitudinally in side-by-side relation to each other. Preferably, the second joint hole 27 arranged on a longitudinally inward side of the primary beam 2 relative to the first joint hole 27′ is formed as a longitudinally-long elongate hole.

As shown in FIGS. 2, 3 and 4, the depressed plate portion 54 of the splice plate 50 is pressed against the two depressed beam portions 26 in the adjacent ends of the longitudinally-aligned pair of primary beams 2, while placing the first and second (i.e., upper and lower) bent plate edge portions of the splice plate 50, on respective ones of the two pairs of first and second (i.e., upper and lower) bent edge plate portions 22, 23 in the adjacent ends of the longitudinally-aligned pair of primary beams 2, from the outside of the two cable racks 1, to push the two lock protrusions 56 of the depressed plate portion 54 of the splice plate 50 into the respective second (longitudinally inward-side) joint holes 27 of the two depressed beam portions 26 in the adjacent ends of the longitudinally-aligned pair of primary beams 2. Through this operation, each of the lock protrusions 56 is engaged by a peripheral edge of a corresponding one of the second joint holes 27.

Then, a threaded portion 62 of a bolt 60 is inserted into the first (longitudinally outward-side) joint hole 27′ in each of the adjacent ends of the longitudinally-aligned pair of primary beams 2, and a corresponding one of the two insertion holes 55 of the splice plate 50, from an inside of the two cable racks 1, and a flange nut 70 is turned after being attached to the inserted bolt 60 from the outside of the two cable rack 1, to clamp the two depressed beam portions 26 in the adjacent ends of the longitudinally-aligned pair of primary beams 2, and the depressed plate portion 54 of the splice plate 50, between a head of the bolt and the flange nut 70.

In the above manner, each of the two longitudinally-aligned pairs of primary beams 2 on both sides of the two cable racks 1 can be joined together in the adjacent ends thereof using the splice plates 50.

The two lock protrusions 56 of the splice plate 50 are engaged by the two joint holes 27 of the longitudinally-aligned pair of primary beams 2. Thus, the longitudinally-aligned pair of primary beams 2 can be joined together by performing a bolting operation only at two positions on one side of the two cable racks 1, i.e., at four positions on both sides of the two cable racks 1. This makes it possible to reduce by half the number of bolting positions, and a time of the joining operation, as compared with the conventional technique.

In addition, a fastening operation using a bolt and a nut is performed at two positions, while maintaining the two lock protrusions 56 in an engaged state at two positions. This makes it possible to eliminate the need for additionally providing the reverse bent portion extending from a distal edge of at least an upper one of the first and second bent plate edge portions 52, 53 of the splice plate 50, in a manner engageable with the first bent edge plate portion 52 of the primary beam 2, as in the conventional technique, so as to facilitate a reduction in production cost.

Furthermore, the above method can cope with cut-off of an end of the primary beam 2 for the purpose of length adjustment, without the problem caused by providing the protrusion in an end of the primary beam, as in the conventional technique.

The positional relationship between the lock protrusions 56 and the insertion holes 55 of the splice plate 50 may be reversed, i.e., each of the insertion holes 55 may be arranged on a longitudinally outward side of the splice plate 50, and each of the lock protrusions 56 may be arranged on a longitudinally inward side of the splice plate 50. Further, the vertical inclination of the lock protrusion 56 may be reversed.

Although not illustrated, each of the lock protrusions 56 may be formed in a cut-and-bent shape in which a triangular region of the depressed plate portion 54 protrudes inwardly, wherein an amount of protrusion in the triangular region gradually increases in a downward direction, and the triangular region has an arc-shaped cut portion 57 in a lower edge thereof, or may be formed in a cut-and-bent shape in which a region of the depressed plate portion 54 protrudes inwardly in upper and lower edges thereof, wherein the region has a cut portion in each of the upper and lower edges thereof.

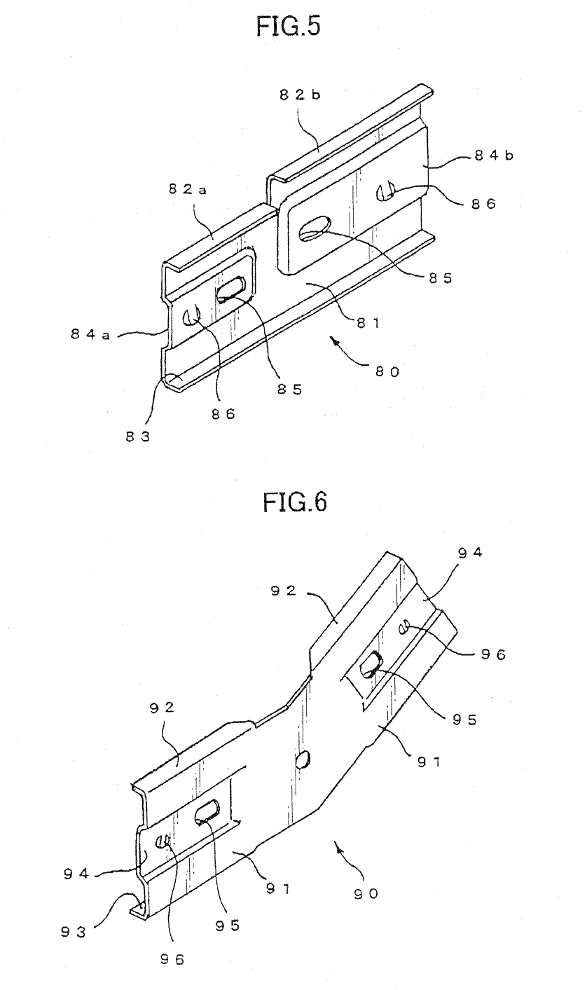

FIG. 5 shows a splice plate 80 according to a second embodiment of the present invention, wherein the splice plate 80 is designed to join together two cable racks different in height dimension of a primary beam, in a longitudinal direction thereof.

Specifically, the splice plate 80 has a vertically planar plate 81 having low and high planar plate portions which are formed to have different height dimensions each conforming to a corresponding one of a longitudinally-aligned pair of primary beams 2 in two racks 1, and arranged in a longitudinal direction thereof; two first bent plate edge portions 82a, 82b extending from respective upper edges of the low and high planar plate portions in such a manner as cover respective adjacent ends of the longitudinally-aligned pair of primary beams 2; a second bent plate edge portion 83 extending from a common lower edge of the low and high planar plate portions in such a manner as cover respective adjacent ends of the longitudinally-aligned pair of primary beams 2; and two vertically planar depressed plate portions 84a, 84b formed by depressing respective generally vertically central regions of the low and high planar plate portions of the planar plate portion 81, inwardly.

Each of the depressed plate portion 84a, 84b has an insertion hole 85 formed at a position corresponding to one of the two first (longitudinally outward-side) joint holes 27′ in the adjacent ends of the longitudinally-aligned pair of primary beams 2, and a lock protrusion 86 protruding inwardly in a manner engageable with the second (longitudinally inward-side) joint hole 27.

FIG. 6 shows a splice plate 90 according to a third embodiment of the present invention, wherein the splice plate 90 is designed to join together respective adjacent ends of each of two longitudinally-aligned pairs of primary beams 2 in two cable racks, in such a manner that a longitudinal-lateral plane (a longitudinal plane including a plurality of secondary beams of the cable rack) of one of the cable racks 1 is inclined relative to that of the other cable rack 1. The splice plate 90 has first and second portions formed integrally to extend outwardly from a central region thereof at a certain inclination angle relative to each other.

Specifically, the splice plate 90 has a vertically planar plate 91 having first and second planar plate portions which are formed integrally at a certain inclination angle relative to each other; two first bent plate edge portions 92 extending from respective upper edges of the first and second planar plate portions of the planar plate portion 91 in such a manner as cover respective adjacent ends of the longitudinally-aligned pair of primary beams 2; two second bent plate edge portions 93 extending from respective lower edges of the first and second planar plate portions of the planar plate portion 91 in such a manner as cover respective adjacent ends of the longitudinally-aligned pair of primary beams 2; and two vertically planar depressed plate portions 94 formed by inwardly depressing respective generally vertically central regions of the first and second planar plate portions of the planar plate portion 91.

Each of the depressed plate portions 94 has an insertion hole 95 formed at a position corresponding to one of the two first (longitudinally outward-side) joint holes 27′ in the adjacent ends of the longitudinally-aligned pair of primary beams 2, and a lock protrusion 96 protruding inwardly in a manner engageable with the second (longitudinally inward-side) joint hole 27.

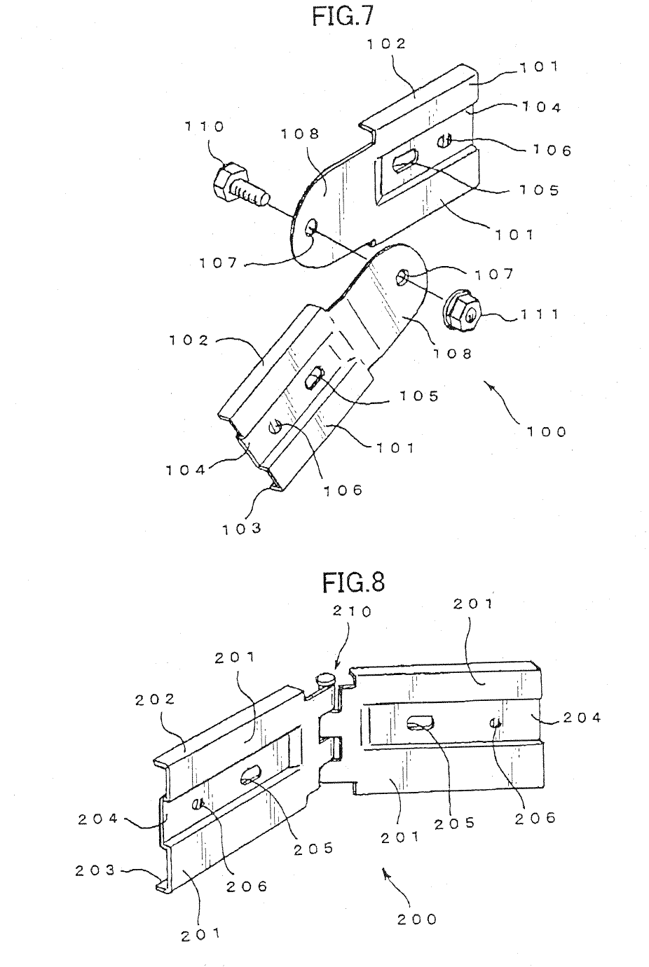

FIG. 7 shows a splice plate 100 according to a fourth embodiment of the present invention, wherein the splice plate 100 is designed to join together respective adjacent ends of each of two longitudinally-aligned pairs of primary beams 2 in two cable racks, in such a manner that the two cable racks are adjustably rotated and positioned relative to each other to allow a longitudinal-lateral plane of one of said two cable racks to be inclined relative to that of the other cable rack.

Specifically, the splice plate 100 has a pair of splice plates, each of which includes: a planar plate portion vertically planar plate 101; first and second bent plate edge portions 102, 103 extending from respective upper and lower edges of the planar plate portion 101 in such a manner as cover respective adjacent ends of the longitudinally-aligned pair of primary beams; vertically planar depressed plate portions 104 formed by inwardly depressing a generally vertically central region of the planar plate portion 101; and a vertically planar coupling portion 108 extending from the planar plate portion 101 and having a coupling hole 107 in a distal end thereof.

The depressed plate portion 104 has an insertion hole 105 formed at a position corresponding to one of the two first (longitudinally outward-side) joint holes 27′ in the adjacent ends of the longitudinally-aligned pair of primary beams 2, and a lock protrusion 106 protruding inwardly in a manner engageable with the second (longitudinally inward-side) joint hole 27.

In the splice plate 100, the respective coupling holes 107 of the coupling portions 108 are aligned with each other, and the pair of the splice plates are rotatably coupled to each other by a bolt 110 and a nut 111.

In this embodiment, the two cable racks are joined together in the following manner. The two depressed plate portions 104 of the pair of splice plates 100 are pressed against the respective two depressed beam portions 26 in the adjacent ends of the longitudinally-aligned pair of primary beams, while placing the two pairs of first and second bent plate edge portions 102, 103 of the pairs of splice plates 100, on the respective ones of the two pairs of first and second bent edge plate portions of the adjacent ends of the longitudinally-aligned pair of primary beams, from the outside of the two cable racks, to bring the two lock protrusions 106 of the pairs of splice plates 100 into engagement with the respective second joint holes 27 of the two depressed beam portions in the adjacent ends of the longitudinally-aligned pair of primary beams. Then, the bolt 60 is inserted into the first joint hole 27′ in each of the adjacent ends of the longitudinally-aligned pair of primary beams, and a corresponding one of the two insertion holes 105 of the pair of splice plates of the splice plate 100, and the nut 70 is fastened to the inserted bolt 60 from the side of a distal end of the inserted bolt 60 to clamp the two depressed beam portions in the adjacent ends of the longitudinally-aligned pair of primary beams, and the two depressed plate portions 104 of the pair of splice plates 100, between the bolt 60 and the nut 70, to fixedly fasten the pair of splice plates 100 to the respective adjacent ends of the longitudinally-aligned pair of primary beams. Then, the pair of splice plates 100 are fixedly fastened together through the coupling holes 107 of the coupling portions 108 of the pair of splice plates 100 by a bolt 110 and a nut 111, while adjustingly rotating and positioning the pair of splice plates 100.

FIG. 8 shows a splice plate 200 according to a fifth embodiment of the present invention, wherein the splice plate 200 is designed to join together respective adjacent ends of each of two longitudinally-aligned pairs of primary beams 2 in two cable racks, in such a manner that the two cable racks are adjustably rotated and positioned relative to each other to allow one of the two cable racks to be inclined laterally relative to the other cable rack in approximately the same longitudinal-lateral plane of the two cable racks in a longitudinally aligned state.

Specifically, the splice plate 200 has a pair of splice plates, each of which includes: a vertically planar plate portion 201; first and second bent plate edge portions 202, 203 extending from respective upper and lower edges of the planar plate portion 201 in such a manner as cover respective adjacent ends of the longitudinally-aligned pair of primary beams; vertically planar depressed plate portions 204 formed by depressing a generally vertically central region of the planar plate portion 201, inwardly.

The depressed plate portion 204 has an insertion hole 205 formed at a position corresponding to one of the two first (longitudinally outward-side) joint holes 27′ in the adjacent ends of the longitudinally-aligned pair of primary beams 2, and a lock protrusion 206 protruding inwardly in a manner engageable with the second (longitudinally inward-side) joint hole 27.

In the splice plate 200, the pair of splice plates are coupled to each other by a pair of pivotally coupling portions (e.g., hinge elements) 210 extending from the respective two plate bodies 201 thereof, in such a manner as to allow one of the pairs of splice plates to be inclined laterally relative to the other splice plates in approximately the same longitudinal-lateral plane of the two cable racks in a longitudinally aligned state.

In this embodiment, the two cable racks are joined together in such a manner that the two cable racks are adjustably rotated and positioned relative to each other to allow one of the two cable racks to be inclined laterally relative to the other cable rack in approximately the same longitudinal-lateral plane of the two cable racks in a longitudinally aligned state, in the following manner. The two depressed plate portions 204 of the pair of splice plates 200 are pressed against the respective two depressed beam portions in the adjacent ends of the longitudinally-aligned pair of primary beams, while placing the two pairs of first and second bent plate edge portions 202, 203 of the pairs of splice plates 200, on the respective ones of the two pairs of first and second bent edge plate portions of the adjacent ends of the longitudinally-aligned pair of primary beams, from the outside of the two cable racks, to bring the two lock protrusions 206 of the pairs of splice plates 100 into engagement with the respective second joint holes 27 of the two depressed beam portions in the adjacent ends of the longitudinally-aligned pair of primary beams. Then, a bolt 60 is inserted into the first joint hole 27′ in each of the adjacent ends of the longitudinally-aligned pair of primary beams, and a corresponding one of the two insertion holes 205 of the pair of splice plates 200, and a nut 70 is fastened to the inserted bolt 60 from the side of a distal end of the inserted bolt 60 to clamp the two depressed beam portions in the adjacent ends of the longitudinally-aligned pair of primary beams, and the two depressed plate portions 204 of the pair of splice plates 200, between the bolt 60 and the nut 70, to fixedly fasten the pair of splice plates of the splice plate 200 to the respective adjacent ends of the longitudinally-aligned pair of primary beams.

In the second to fifth embodiments illustrated in FIGS. 5 to 8, it is understood that the lock protrusion may be formed in any other suitable shape. Further, the positional relationship between the insertion hole and the lock protrusion may be reversed, as described in connection with the first embodiment.

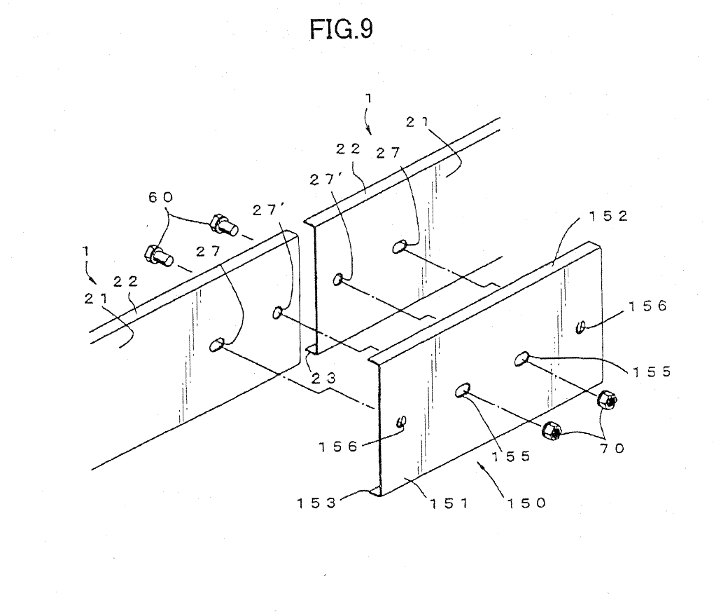

The above embodiments are intended to be used for one type of cable rack 1 where a vertically planar plate portion 21 of a primary beam 2 has a vertically planner depressed plate portion. In another type of cable rack 1 as shown in FIG. 9, where no vertically planner depressed plate portion is provided in a vertically planar plate portion 21 of a primary beam 2, and two joint holes 27, 27′ are formed in the planar plate portion 21, a vertically planner depressed plate portion is not provided in a splice plate 150.

Specifically, the splice plate 150 illustrated in FIG. 9 has: a vertically planar plate 151; and first and second bent plate edge portions 152, 153 extending from respective upper and lower edges of the planar plate portion 151 in such a manner as to cover respective adjacent ends of each of two longitudinally-aligned pairs of the primary beams of the two cable racks, from an outside of the two cable racks. The planar plate portion has two insertion holes 155 each formed at a position corresponding to a first (longitudinally outward-side) one of the two joint holes 27′ in each of the adjacent ends of the longitudinally-aligned pair of primary beams, and two lock protrusions 156 each formed as a cut-and-bent portion to protrude inwardly, at a position corresponding to the other second (longitudinally inward-side) joint hole 27, in a manner engageable with the second joint hole 27

In this embodiment, the two cable racks are joined together in the following manner. As shown in FIG. 9, the planar plate portion 151 of the splice plate 150 is pressed against the two planar plate portions 21 in the adjacent ends of the longitudinally-aligned pair of primary beams 2, while placing the first and second bent plate edge portions 152, 153 of the splice plate 150, on respective ones of the two pairs of first and second bent edge plate portions 22, 23 in the adjacent ends of the longitudinally-aligned pair of primary beams 2, from the outside of the two cable racks, to push the two lock protrusions 156 of the planar plate portion 151 of the splice plate 50 into the respective second (longitudinally inward-side) joint holes 27 in such a manner as to bring the two lock protrusions 156 in engagement with respective peripheral edges of the respective second joint holes 27.

Then, a threaded portion 62 of a bolt 60 is inserted into the first joint hole 27′ in each of the adjacent ends of the longitudinally-aligned pair of primary beams 2, from the inside of the two cable racks, and a corresponding one of the two insertion holes 155 of the splice plate 150, and a flange nut 70 is fastened to the inserted bolt 60 from the side of a distal end of the inserted bolt 60 and turned, from the outside of the two racks, to clamp the two planar plate portions 21 in the adjacent ends of the longitudinally-aligned pair of primary beams 2, and the planar plate portion 151 of the splice plate 150, between a head 63 of the bolt 60 and the flange nut 70. In the above manner, each of the two longitudinally-aligned pairs of primary beams 2 on both sides of the two cable racks 1 can be joined together in the adjacent ends thereof using the splice plates 150. When a cable rack is the type as shown in FIG. 9, where no vertically planner depressed plate portion is provided in the planar plate portion 21 of the primary beam 2, and the two joint holes 27, 27′ are formed in the planar plate portion 21, each of the splice plate 80 illustrated in FIG. 5, the splice plate 90 illustrated in FIG. 6, the splice plate 100 illustrated in FIG. 7, and the splice plate 200 illustrated in FIG. 8, may also be designed to form two insertion holes and two lock protrusion in each of the planar plate portion 81, 91, 101, 201, without providing the depressed plate portion.

What is claimed is:

1. A method of joining respective adjacent ends of two cable racks together in a longitudinal direction thereof, wherein each of said cable racks having two primary beams each having a vertically planar plate portion, and first and second bent edge plate portions extending from respective upper and lower edges of said planar plate portion inwardly in a direction perpendicular to said planar plate portion; and a plurality of secondary beams connecting said two primary beams together in such a manner that opposite ends of each of said secondary beams are fixed to respective upper surfaces of said second bent edge plate portions of said two primary beams, and wherein each of said two primary beams has two joint holes which are formed in each of opposite longitudinal ends of said planar plate portion, and arranged longitudinally in side-by-side relation to each other, said method comprising the steps of:
aligning said two cable racks to each other in the longitudinal direction thereof;
providing a splice plate which has: a vertically planar plate portion; and first and second bent plate edge portions extending from respective upper and lower edges of said planar plate portion in such a manner as to cover respective adjacent ends of each of two longitudinally-aligned pairs of said primary beams of said two cable racks, from an outside of said two cable racks, wherein said planar plate portion has two insertion holes each formed at a position corresponding to a first one of said two joint holes in each of said adjacent ends of said longitudinally-aligned pair of primary beams, and two lock protrusions, each formed at a position corresponding to the other second joint hole in each of said adjacent ends of said pair of primary beams, in a manner engageable these with;
pressing said planar plate portion of said splice plate against said two planar plate portion of said adjacent ends of said longitudinally-aligned pair of primary beams, while placing said first and second bent plate edge portions of said splice plate on respective ones of said two pairs of first and second bent edge plate portions of said adjacent ends of said longitudinally-aligned pair of primary beams, from the outside of said two cable racks, to bring said two lock protrusions of said planar plate portion of said splice plate into engagement with said respective second joint holes of said two planar plate portions of said adjacent ends of said longitudinally-aligned pair of primary beams; and
inserting a bolt into said first joint hole in each of said adjacent ends of said longitudinally-aligned pair of primary beams, and a corresponding one of said two insertion holes of said splice plate, and fastening a nut to said inserted bolt from the side of a distal end of said inserted bolt to clamp said two planar plate portions of said adjacent ends of said longitudinally-aligned pair of primary beams, and said planar plate portion of said splice plate, between said bolt and said nut.

2. A splice plate for joining together respective adjacent ends of two primary beams aligned in a longitudinal direction thereof, each of said adjacent ends of said two primary beams being formed with two joint holes in side-by-side arrangement in the longitudinal direction, said splice plate comprising:
a vertically planar plate portion having two insertion holes, each formed at a position corresponding to a first one of said two joint holes formed in each of said adjacent ends of said two primary beams, and two lock protrusions each formed at a position corresponding to the other second joint hole, in a manner engageable with said second joint hole; and
first and second bent plate edge portions extending from respective upper and lower edges of said planar plate portion in such a manner as to cover said respective adjacent ends of said two primary beams.

3. A method of joining respective adjacent ends of two cable racks together in a longitudinal direction thereof, wherein each of said cable racks has two primary beams, each having a planar plate portion, first and second bent edge plate portions extending from respective upper and lower edges of said planar plate portion inwardly in a direction perpendicular to said planar plate portion, and a planar depressed plate portion formed by depressing a generally vertically central region of said planar plate portion; and a plurality of secondary beams connecting said two primary beams together in such a manner that opposite ends of each of said secondary beams are fixed to respective upper surfaces of said second bent edge plate portions of said two primary beams, and wherein each of said two primary beams has two joint holes which are formed in each of opposite longitudinal ends of said depressed plate portion, and arranged longitudinally in side-by-side relation to each other, said method comprising the steps of:
aligning said two cable racks to each other in the longitudinal direction thereof;
providing a splice plate which has a vertically planar plate portion; first and second bent plate edge portions extending from respective upper and lower edges of said planar plate portion in such a manner as to cover respective adjacent ends of each of two longitudinally-aligned pairs of said primary beams of said two cable racks, from an outside of said two cable racks; and a planar depressed plate portion formed by depressing a generally vertically central region of said planar plate portion inwardly, said depressed plate portion having two insertion holes each formed at a position corresponding to a first one of said two joint holes in each of said adjacent ends of said longitudinally-aligned pair of primary beams, and two lock protrusions, each formed at a position corresponding to the other second joint hole, in a manner engageable with said second joint hole;
pressing said depressed plate portion of said splice plate, against said two depressed plate portions of said adjacent ends of said longitudinally-aligned pair of primary beams, while placing said first and second bent plate edge portions of said splice plate, on the respective ones of said two pairs of first and second bent edge plate portions of said adjacent ends of said longitudinally-aligned pair of primary beams, from the outside of said two cable racks, to bring said two lock protrusions of said depressed plate portion of said splice plate into engagement with said respective second joint holes of said two depressed beam portions in said adjacent ends of said longitudinally-aligned pair of primary beams; and
inserting a bolt into said first joint hole in each of said adjacent ends of said longitudinally-aligned pair of primary beams, and a corresponding one of said two insertion holes of said splice plate, and fastening a nut to said inserted bolt from the side of a distal end of said inserted bolt to clamp said two depressed plate portions of said adjacent ends of said longitudinally-aligned pair of primary beams, and said depressed plate portion of said splice plate, between said bolt and said nut.

4. A splice plate for joining together respective adjacent ends of two primary beams aligned in a longitudinal direction thereof, each of said adjacent ends of said two primary beams being formed with two joint holes in side-by-side arrangement in said longitudinal direction, said splice plate comprising:
a vertically planar plate portion;
first and second bent plate edge portions extending from respective upper and lower edges of said planar plate portion in such a manner as to cover said respective adjacent ends of said two primary beams; and
a planar depressed plate portion formed by depressing a generally vertically central region of said planar plate portion inwardly, said depressed plate portion having two insertion holes, each formed at a position corresponding to a first one of said two joint holes in each of said adjacent ends of said two primary beams, and two lock protrusions, each formed at a position corresponding to the other second joint hole, in a manner engageable with said second joint hole

5. A method of joining respective adjacent ends of two cable racks together, in such a manner that said two cable racks are adjustably rotated and positioned relative to each other to allow a longitudinal-lateral plane of one of said two cable racks to be inclined relative to that of the other cable rack, wherein each of said cable racks has two primary beams, each having a vertically planar plate portion, and first and second bent edge plate portions extending from respective upper and lower edges of said planar plate portion inwardly in a direction perpendicular to said planar plate portion; and a plurality of secondary beams connecting said two primary beams together in such a manner that opposite ends of each of said secondary beams are fixed to respective upper surfaces of said second bent edge plate portions of said two primary beams, and wherein each of said two primary beams has two joint holes which are formed in each of opposite longitudinal ends of said planar plate portion, and arranged longitudinally in side-by-side relation to each other, said method comprising the steps of:
aligning said two cable racks to each other in a longitudinal direction thereof;
providing a pair of splice plates, each of which includes a vertically planar plate portion, first and second bent plate edge portions extending from respective upper and lower edges of said planar plate portion in such a manner as to cover respective adjacent ends of each of two longitudinally-aligned pairs of said primary beams of said two cable racks, from an outside of said two cable racks, and a vertically planar coupling portion extending from said planar plate portion and having a coupling hole formed in a distal end thereof, wherein said planar plate portion has an insertion hole formed at a position corresponding to a first one of said two joint holes in each of said adjacent ends of said longitudinally-aligned pair of primary beams, and a lock protrusion formed at a position corresponding to the other second joint hole, in a manner engageable with said second joint hole,
pressing said two plate bodies of said pair of splice plates, against said respective two planar plate portions of said adjacent ends of said longitudinally-aligned pair of primary beams, while placing said two pairs of first and second bent plate edge portions of said pair of splice plates, on the respective ones of said two pairs of first and second bent edge plate portions of said adjacent ends of said longitudinally-aligned pair of primary beams, from the outside of said two cable racks, to bring said two lock protrusions of said plate bodies of said pairs of splice plates into engagement with said respective second joint holes of said two planar plate portions of said adjacent ends of said longitudinally-aligned pair of primary beams,
inserting a bolt into said first joint hole in each of said adjacent ends of said longitudinally-aligned pair of primary beams, and a corresponding one of said two insertion holes of said pair of splice plates, and fastening a nut to said inserted bolt from the side of a distal end of said inserted bolt to clamp said two planar plate portions of said adjacent ends of said longitudinally-aligned pair of primary beams, and said two plate bodies of said pair of splice plates, between said bolt and said nut, to fixedly fasten said pair of splice plates to said respective adjacent ends of said longitudinally-aligned pair of primary beams, and
fixedly fastening said pair of splice plates together through said coupling holes of said coupling portions of said pair of splice plates by a bolt and a nut, while adjustingly rotating and positioning said pair of splice plates.

6. A splice plate for joining together respective adjacent ends of two primary beams aligned in a longitudinal direction thereof, each of said adjacent ends of said two primary beams being formed with two joint holes in side-by-side arrangement in said longitudinal direction, said—pair of splice plates each including:
a vertically planar plate portion having an insertion hole formed at a position corresponding to a first one of said two joint holes in each of said adjacent ends of said two primary beams, and a lock protrusion formed at a position corresponding to the other, second joint hole in a manner engageable with said second joint hole;
first and second bent plate edge portions extending from respective upper and lower edges of said planar plate portion in such a manner as to cover said respective adjacent ends of said two primary beams; and
a vertically planar coupling portion extending from said planar plate portion and having a coupling hole formed in a distal end thereof,
wherein said pair of splice plates are adapted to be fixedly fastened together through said coupling holes of said coupling portions of said pair of splice plates by a bolt and a nut, while adjustingly rotating and positioning said pair of splice plates.

7. A method of joining respective adjacent ends of two cable racks together, in such a manner that said two cable racks are adjustably rotated and positioned relative to each other to allow a longitudinal-lateral plane of one of said two cable racks to be inclined relative to that of the other cable rack, wherein each of said cable racks has two primary beams, each having a vertically planar plate portion, first and second bent edge plate portions extending from respective upper and lower edges of said planar plate portion inwardly in a direction perpendicular to said planar plate portion, and a vertically planar depressed plate portion formed by depressing a generally vertically central region of said planar plate portion; and a plurality of secondary beams connecting said two primary beams together in such a manner that opposite ends of each of said secondary beams are fixed to respective upper surfaces of said second bent edge plate portions of said two primary beams, and wherein each of said two primary beams has two joint holes which are formed in each of opposite longitudinal ends of said depressed plate portion, and arranged longitudinally in side-by-side relation to each other, said method comprising the steps of:
aligning said two cable racks to each other in a longitudinal direction thereof;
providing a pair of splice plate, each of which includes: a vertically planar plate portion; first and second bent plate edge portions extending from respective upper and lower edges of said planar plate portion in such a manner as to cover respective adjacent ends of each of two longitudinally-aligned pairs of said primary beams of said two cable racks, from an outside of said two cable racks; and a vertically planar depressed plate portion formed by depressing a generally vertically central region of said planar plate portion inwardly; and a vertically planar coupling portion extending from said planar plate portion and having a coupling hole formed in a distal end thereof, wherein said depressed plate portion has an insertion hole formed at a position corresponding to a first one of said two joint holes in each of said adjacent ends of said longitudinally-aligned pair of primary beams, and a lock protrusion formed at a position corresponding to the other second joint hole, in a manner engageable with said second joint hole;
pressing said two depressed plate portions of said pair of splice plates, against said respective two depressed plate portions in said adjacent ends of said longitudinally-aligned pair of primary beams, while placing said two pairs of first and second bent plate edge portions of said pairs of splice plates, on the respective ones of said two pairs of first and second bent edge plate portions of said adjacent ends of said longitudinally-aligned pair of primary beams, from the outside of said two cable racks, to bring said two lock protrusions of said depressed plate portions of said pairs of splice plates into engagement with said respective second joint holes of said two depressed plate portions in said adjacent ends of said longitudinally-aligned pair of primary beams;
inserting a bolt into said first joint hole in each of said adjacent ends of said longitudinally-aligned pair of primary beams, and a corresponding one of said two insertion holes of said pair of splice plates, and fastening a nut to said inserted bolt from the side of a distal end of said inserted bolt to clamp said two depressed plate portions of said adjacent ends of said longitudinally-aligned pair of primary beams, and said two depressed plate portions of said pair of splice plates, between said bolt and said nut, to fixedly fasten said pair of splice plates to said respective adjacent ends of said longitudinally-aligned pair of primary beams; and
fixedly fastening said pair of splice plates together through said coupling holes of said coupling portions of said pair of splice plates by a bolt and a nut, while adjustingly rotating and positioning said pair of splice plates.

8. A pair of splice plates for joining together respective adjacent ends of two primary beams aligned in a longitudinal direction thereof, each of said adjacent ends of said two primary beams being formed with two joint holes in side-by-side arrangement in said longitudinal direction, said pair of splice plates, each including:
a vertically planar plate portion;
first and second bent plate edge portions extending from respective upper and lower edges of said planar plate portion in such a manner as to cover said respective adjacent ends of said two primary beams;
a vertically planar depressed plate portion formed by depressing a generally vertically central region of said planar plate portion inwardly, said depressed plate portion having an insertion hole formed at a position corresponding to a first one of said two joint holes in each of said adjacent ends of said longitudinally-aligned pair of primary beams, and a lock protrusion formed at a position corresponding to the other second joint hole, in a manner engageable with said second joint hole; and
a vertically planar coupling portion extending from said planar plate portion and having a coupling hole formed in a distal end thereof,
wherein said pair of splice plates are adapted to be fixedly fastened while being adjustingly rotated and positioned, by means of a bolt inserted into said two coupling holes of said coupling portions of said pair of splice plates, and a nut fastened to said bolt.

9. A method of joining respective adjacent ends of two cable racks together, in such a manner that said two cable racks are adjustably rotated and positioned relative to each other to allow one of said two cable racks to be inclined laterally relative to the other cable rack in approximately the same longitudinal-lateral plane of said two cable racks in a longitudinally aligned state, wherein each of said cable racks has two primary beams each having a vertically planar plate portion, and first and second bent edge plate portions extending from respective upper and lower edges of said planar plate portion inwardly in a direction perpendicular to said planar plate portion; and a plurality of secondary beams connecting said two primary beams together in such a manner that opposite ends of each of said secondary beams are fixed to respective upper surfaces of said second bent edge plate portions of said two primary beams, and wherein each of said two primary beams has two joint holes which are formed in each of opposite longitudinal ends of said planar plate portion, and arranged longitudinally in side-by-side relation to each other, said method comprising the steps of:
aligning said two cable racks to each other in a longitudinal direction thereof;
providing a pair of splice plates, each of which includes: a vertically planar plate portion; and first and second bent plate edge portions extending from respective upper and lower edges of said planar plate portion in such a manner as to cover respective adjacent ends of each of two longitudinally-aligned pairs of said primary beams of said two cable racks, from an outside of said two cable racks, wherein said planar plate portion has an insertion hole formed at a position corresponding to a first one of said two joint holes in each of said adjacent ends of said longitudinally-aligned pair of primary beams, and a lock protrusion formed at a position corresponding to the other second joint hole, in a manner engageable with said second joint hole, and wherein said pair of splice plates are coupled to each other by a pair of pivotally coupling portions extending from said respective two plate bodies thereof, in such a manner as to allow one of said pairs of splice plates to be inclined laterally relative to the other splice plate in approximately the same longitudinal-lateral plane of said two aligned cable racks;
pressing said two plate bodies of said pair of splice plates, against said respective two planar plate portions of said adjacent ends of said longitudinally-aligned pair of primary beams, while placing said two pairs of first and second bent plate edge portions of said pair of splice plates, on the respective ones of said two pairs of first and second bent edge plate portions of said adjacent ends of said longitudinally-aligned pair of primary beams, from the outside of said two cable racks, to bring said two lock protrusions of said plate bodies of said pairs of splice plates into engagement with said respective second joint holes of said two planar plate portions of said adjacent ends of said longitudinally-aligned pair of primary beams; and
inserting a bolt into said first joint hole in each of said adjacent ends of said longitudinally-aligned pair of primary beams, and a corresponding one of said two insertion holes of said pair of splice plates, and fastening a nut to said inserted bolt from the side of a distal end of said inserted bolt to clamp said two planar plate portions of said adjacent ends of said longitudinally-aligned pair of primary beams, and said two plate bodies of said pair of splice plates, between said bolt and said nut, to fixedly fasten said pair of splice plats to said respective adjacent ends of said longitudinally-aligned pair of primary beams.

10. A pair of splice plates for joining together respective adjacent ends of two primary beams aligned in a longitudinal direction thereof, each of said adjacent ends of said two primary beams being formed with two joint holes in side-by-side arrangement in said longitudinal direction, said pair of splice plates each including:
a vertically planar plate portion having an insertion hole formed at a position corresponding to a first one of said two joint holes in each of said adjacent ends of said two primary beams, and a lock protrusion formed at a position corresponding to the other, second joint hole in a manner engageable with said second joint hole; and
first and second bent plate edge portions extending from respective upper and lower edges of said planar plate portion in such a manner as to cover respective adjacent ends of said two primary beams,
wherein said pair of splice plates are coupled to each other by a pair of pivotally coupling portions extending from said respective two plate bodies thereof in such a manner as to allow one of said pairs of splice plates to be inclined laterally relative to the other splice plate in approximately the same longitudinal-lateral plane of said two aligned cable racks.

11. A method of joining respective adjacent ends of two cable racks together, in such a manner that said two cable racks are adjustably rotated and positioned relative to each other to allow one of said two cable racks to be inclined laterally relative to the other cable rack in approximately the same longitudinal-lateral plane of said two cable racks in a longitudinally aligned state, wherein each of said cable racks has two primary beams each having a vertically planar plate portion, first and second bent edge plate portions extending from respective upper and lower edges of said planar plate portion inwardly in a direction perpendicular to said planar plate portion, and a vertically planar depressed plate portion formed by depressing a generally vertically central region of said planar plate portion; and a plurality of secondary beams connecting said two primary beams together in such a manner that opposite ends of each of said secondary beams are fixed to respective upper surfaces of said second bent edge plate portions of said two primary beams, and wherein each of said two primary beams has two joint holes which are formed in each of opposite longitudinal ends of said depressed plate portion, and arranged longitudinally in side-by-side relation to each other, said method comprising the steps of:
aligning said two cable racks to each other in a longitudinal direction thereof;
providing a pair of splice plates, each of which includes: a vertically planar plate portion; first and second bent plate edge portions extending from respective upper and lower edges of said planar plate portion in such a manner as to cover respective adjacent ends of each of two longitudinally-aligned pairs of said primary beams of said two cable racks, from an outside of said two cable racks; and a vertically planar depressed plate portion formed by depressing a generally vertically central region of said planar plate portion inwardly, said depressed plate portion having an insertion hole formed at a position corresponding to a first one of said two joint holes in each of said adjacent ends of said longitudinally-aligned pair of primary beams, and a lock protrusion formed at a position corresponding to the other second joint hole, in a manner engageable with said second joint hole, wherein said pair of splice plates are coupled to each other by a pair of pivotally coupling portions extending from said respective two plate bodies thereof, in such a manner as to allow one of said pairs of splice plates to be inclined laterally relative to the other splice plate in approximately the same longitudinal-lateral plane of said two aligned cable racks;
pressing said two depressed plate portions of said pair of splice plates, against said respective two depressed beam portions in said adjacent ends of said longitudinally-aligned pair of primary beams, while placing said two pairs of first and second bent plate edge portions of said pairs of splice plates, on the respective ones of said two pairs of first and second bent edge plate portions of said adjacent ends of said longitudinally-aligned pair of primary beams, from the outside of said two cable racks, to bring said two lock protrusions of said depressed plate portions of said pairs of splice plates into engagement with said respective second joint holes of said two depressed beam portions in said adjacent ends of said longitudinally-aligned pair of primary beams; and
inserting a bolt into said first joint hole in each of said adjacent ends of said longitudinally-aligned pair of primary beams, and a corresponding one of said two insertion holes of said pair of splice plates, and fastening a nut to said inserted bolt from the side of a distal end of said inserted bolt to clamp said two depressed beam portions in said adjacent ends of said longitudinally-aligned pair of primary beams, and said two depressed plate portions of said pair of splice plates, between said bolt and said nut, to fixedly fasten said pair of splice plates to said respective adjacent ends of said longitudinally-aligned pair of primary beams.

12. A pair of splice plates for joining together respective adjacent ends of two primary beams aligned in a longitudinal direction thereof, each of said adjacent ends of said two primary beams being formed with two joint holes in side-by-side arrangement in said longitudinal direction, said pair of splice plates each including:
a vertically planar plate portion;
first and second bent plate edge portions extending from respective upper and lower edges of said planar plate portion in such a manner as to cover said respective adjacent ends of said two primary beams; and
a vertically planar depressed plate portion formed by depressing a generally vertically central region of said planar plate portion inwardly, said depressed plate portion having an insertion hole formed at a position corresponding to a first one of said two joint holes in each of said adjacent ends of said longitudinally-aligned pair of primary beams, and a lock protrusion formed at a position corresponding to the other second joint hole, in a manner engageable with said second joint hole,
wherein said pair of splice plates are coupled to each other by a pair of pivotally coupling portions extending from said respective two planner plate portions thereof in such a manner as to allow one of said pairs of splice plates to be inclined laterally relative to the other splice plate in approximately the same longitudinal-lateral plane of said two aligned cable racks.
